(19) United States
(12) Patent Application Publication
(10) Pub. No.: US 2004/0069949 A1
(43) Pub. Date: Apr. 15, 2004

(54) Method, apparatus and program for restoring phase information

(75) Inventor: Hideyuki Sakaida, Kaisei-machi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/677,241

(22) Filed: Oct. 3, 2003

(30) Foreign Application Priority Data
Oct. 4, 2002 (JP) 2002-292642

(51) Int. Cl. G01T 1/00

(52) U.S. Cl. 250/358.1

(57) ABSTRACT

In a method of restoring phase information, the estimated accuracy of phase is enhanced by correcting blue amount, which is caused by a focal size of a radiation source, in X-ray intensity to be used in a solving method such as the finite-element method. The method includes the steps of: (a) correcting blur amount for at least one of plural sets of detection data obtained by detecting intensity of radiation on plural detection planes at different distances from the object; (b) obtaining differential data representing difference between the plural sets of detection data where the blur amount has been corrected for at least one thereof; (c) obtaining Laplacian of phase on the basis of the differential data and the detection data; and (d) obtaining phase data of the radiation by performing inverse Laplacian computation on the Laplacian of phase.

### BACKGROUND OF THE INVENTION

1. Field of the Invention

The present invention relates to a method, an apparatus and a program for restoring phase information, which are used for constituting an image on the basis of image information obtained by radiation imaging. In this application, the word “radiation” is used in a broad sense that includes corpuscular beams such electron beams, and electromagnetic waves, in addition to X-rays, α-rays, β-rays, γ-rays, ultraviolet rays and the like.

2. Description of a Related Art

Conventionally, an imaging method using X-rays or the like is utilized in various fields, and employed as one of the most important means for diagnosis, particularly, in a medical field. Since a first X-ray photograph was realized, X-ray photography has been repeatedly improved and a method using a combination of a fluorescent screen and an X-ray film is predominantly used at present. On the other hand,in recent years, various digitized devices such as X-ray CT, ultrasonic or MRI are in practical use and establishment of a diagnostic information processing system and the like in hospitals is being promoted. As for X-ray images, many studies have also been made for digitizing an imaging system. The digitization of the imaging system enables a long-term preservation of a large amount of data without incurring deterioration in image quality and can contribute to development into the medical diagnostic information system.

Incidentally, thus obtainable radiation images are generated by converting intensity of radiation or the like transmitted through an object into brightness of the image. For example, in the case of imaging a region including a bone part, the radiation transmitted through the bone part is largely attenuated, and the radiation transmitted through a region other than the bone part, namely, a soft part is slightly attenuated. In this case, since the difference in the intensity of the radiation transmitted through different tissues is large, the radiation image with high contrast can be obtained.

On the other hand, for example, in the case of imaging a region of the soft part such as a breast, since the radiation is apt to transmit wholly in the soft part, the difference between tissues in the soft part hardly appears as the difference in the intensity of the transmitted radiation. Because of this, as for the soft part, only a radiation image with low contrast can be obtained. Thus, the conventional radiation imaging method is not suitable as a method of visualizing slight difference between tissues in the soft part.

Herein, information contained in radiation transmitted through an object includes phase information in addition to intensity information. In recent years, a phase contrast method has been studied in which an image is generated by using the phase information. The phase contrast method is a phase information restoration technique for converting the phase difference resulted by transmitting X-rays or the like through the object into the brightness of the image.

Examples of the phase contrast method include a method of obtaining the phase difference on the basis of interference X-rays generated by using an interferometer or a zone plate, and a method of obtaining the phase difference on the basis of diffracted X-rays. Among them, in the method of obtaining the phase difference on the basis of the diffracted X-rays, which method is called as a diffraction method, the phase difference is obtained on the basis of the following principle. For example, X-ray propagates through substance because a wave progresses similarly to light. Propagation velocity thereof varies depending on a refractive index of the substance. Therefore, when X-rays having a uniform phase are irradiated toward an object to be inspected, a difference is made in propagation ways of the X-rays, depending on the difference between tissues in the object. For this reason, a wave front of the X-rays transmitted through the object is distorted and, as a result, diffraction fringes are produced on an X-ray image obtained on the basis of the transmitted X-rays. A pattern of the diffraction fringes varies depending on the distance between a screen on which the X-ray image is formed and the object, or wavelength of the X-ray. Accordingly, by analyzing two or more sheets of X-ray images having different diffraction fringe patterns, phase difference of X-rays, which is produced at each position of the screen, can be obtained. By converting the phase difference into the brightness, the X-ray image, in which difference between tissues in the object clearly appears, can be obtained.

In particular, in the radiation transmitted through a soft part of an object, the phase difference is larger than the intensity difference depending on the difference of tissues through which the radiation has transmitted, and therefore, delicate difference between tissues can be visualized by using the phase contrast method. For the purpose of using such a phase contrast method, imaging conditions in the radiation imaging or techniques for restoring the phase from the diffraction fringe pattern are being studied.

B. E. Allman et al., “Noninterferometric quantitative phase imaging with soft x rays”, J. Optical Society of America A, Vol. 17, No. 10 (October 2000) pp. 1732-1743 discloses that the phase restoration is performed on the basis of image information obtained by imaging with soft X-rays to constitute an X-ray image. In this reference, TIE (transport of intensity equation) is used, which is the basic equation of the phase restoration.

$$κ \frac{\partial I ( r )}{\partial z} = - {∇}_{⊥} \cdot \{ I ( r ) {∇}_{⊥} φ ( r ) \} \qquad ( 1 )$$

where r is a vector r=(x, y, z),

$${∇}_{⊥} = ( \frac{\partial }{\partial x} , \frac{\partial }{\partial y} )$$

and κ is a wave number.

Next, principle of the phase restoration is described by referring to FIG. 9. As shown in FIG. 9, the X-ray having wavelength of λ emits from the left side of the figure, transmits through an object plane 101 and enters a screen 102 at a distance of z from the object plane 101. At this time, when assuming intensity of the X-ray and phase thereof at a position (x, y) on the screen 102 to be I(x, y) and φ(x, y) respectively, relationship represented by the following expression holds between the intensity I(x, y) and the phase φ(x, y). Here, the intensity I is the square of amplitude of the wave.

$$\frac{2 π}{λ} \frac{\partial I ( x , y )}{\partial z} = - ∇ \cdot \{ I ( x , y ) ∇ φ ( x , y ) \} \qquad ( 2 )$$

In the expression (2), by putting κ=2π/λ and rewriting (x, y) component into a vector r, the TIE represented by the expression (1) is derived.

However, the TIE has been principally approximated due to difficulty of solving such a TIE. T. E. Gureyev et al., “Hard X-ray quantitative non-interferometric phase-contrast imaging”, SPIE Vol. 3659 (1999) pp. 356-364, discloses that the phase restoration is performed on the basis of image information obtained by imaging with hard X-rays to constitute an X-ray image. In this reference, the TIE represented by the expression (1) is approximated as follows. First, the expression (1) is developed. In the following expression, the vector r in the above document is rewritten into (x, y) components.

$$- κ \frac{\partial I ( x , y )}{\partial z} = ( \frac{\partial }{\partial x} , \frac{\partial }{\partial y} ) \cdot ( I ( x , y ) \frac{\partial φ ( x , y )}{\partial x} , I ( x , y ) \frac{\partial φ ( x , y )}{\partial y} ) = \frac{\partial }{\partial x} ( I ( x , y ) \frac{\partial φ ( x , y )}{\partial x} ) + \frac{\partial }{\partial y} ( I ( x , y ) \frac{\partial φ ( x , y )}{\partial y} ) = I ( x , y ) ( \frac{{\partial }^{2} φ ( x , y )}{\partial {x}^{2}} + \frac{{\partial }^{2} φ ( x , y )}{\partial {y}^{2}} ) + \frac{\partial I ( x , y )}{\partial x} \frac{\partial φ ( x , y )}{\partial x} + \frac{\partial I ( x , y )}{\partial y} \frac{\partial φ ( x , y )}{\partial y} = I ( x , y ) {∇}^{2} φ ( x , y ) + ∇ I ( x , y ) \cdot ∇ φ ( x , y ) \\ where \\ {∇}^{2} = \frac{{\partial }^{2}}{\partial {x}^{2}} + \frac{{\partial }^{2}}{\partial {y}^{2}} \qquad ( 3 )$$

When the second term of the right side in the expression (3) is approximated to zero, an approximate expression represented by the following expression (4) is obtained.

$$\frac{\partial I ( x , y )}{\partial z} ≅ - \frac{I ( x , y )}{κ} {∇}^{2} φ ( x , y ) \qquad ( 4 )$$

In the expression (4), by using intensity I(x, y) of a plurality of X-rays which entered the screen 102 at a different distance of z from the object plane 101, φ(x, y) can be obtained by a solving method such as the finite-element method.

However, an X-ray source for generating X-ray has a finite focal size, and therefore, blur is produced on intensity I(x, y) of the X-rays which come on the screen 102. At that time, when changing a distance between the object plane 101 and the screen 102, the blur amount of the intensity varies. Therefore, in the case where simply calculating a difference between two intensities I(x, y) to obtain φ(x, y) by a solving method such as the finite-element method, an error due to different blur amounts is produced.

### SUMMARY OF THE INVENTION

The present invention has been accomplished to solve the above-mentioned problems. An object of the present invention is to enhance estimated accuracy of phase by correcting blur amount, which is caused by a focal size of a radiation source, in X-ray intensity to be used in a solving method such as the finite-element method.

To solve the above-mentioned problems, a phase information restoring method according to the present invention is a method of restoring phase information on radiation transmitted through an object on the basis of detection data obtained by detecting intensity of the radiation transmitted through the object. The method comprises the steps of: (a) correcting blur amount for at least one of plural sets of detection data obtained by detecting intensity of radiation on plural detection planes at different distances from the object, the plural sets of detection data representing radiation image information on the plural detection planes, respectively; (b) obtaining differential data representing difference between first detection data and second detection data of the plural sets of detection data where the blur amount has been corrected for at least one thereof; (c) obtaining Laplacian of phase on the basis of the differential data and any one of the plural sets of detection data and the detection data in which the blur amount has been corrected; and (d) obtaining phase data of the radiation by performing inverse Laplacian computation on the Laplacian of phase.

A phase information restoring apparatus according to the present invention is an apparatus for restoring phase information on radiation transmitted through an object on the basis of detection data obtained by detecting intensity of the radiation transmitted through the object. The apparatus comprises: blur correcting means for correcting blur amount for at least one of plural sets of detection data obtained by detecting intensity of radiation on plural detection planes at different distances from the object, the plural sets of detection data representing radiation image information on the plural detection planes, respectively; difference processing means for obtaining differential data representing difference between first detection data and second detection data of the plural sets of detection data where the blur amount has been corrected for at least one thereof; Laplacian processing means for obtaining Laplacian of phase on the basis of the differential data and any one of the plural sets of detection data and the detection data in which the blur amount has been corrected; and inverse Laplacian processing means for obtaining phase data of the radiation by performing inverse Laplacian computation on the Laplacian of phase.

A phase information restoring program according to the present invention is a program for restoring phase information on radiation transmitted through an object on the basis of detection data obtained by detecting intensity of the radiation transmitted through the object. The program actuates a CPU to execute the procedures of: (a) correcting blur amount for at least one of plural sets of detection data obtained by detecting intensity of radiation on plural detection planes at different distances from the object, the plural sets of detection data representing radiation image information on the plural detection planes, respectively; (b) obtaining differential data representing difference between first detection data and second detection data of the plural sets of detection data where the blur amount has been corrected for at least one thereof; (c) obtaining Laplacian of phase on the basis of the differential data and any one of the plural sets of detection data and the detection data in which the blur amount has been corrected; and (d) obtaining phase data of the radiation by performing inverse Laplacian computation on the Laplacian of phase.

According to the present invention, the estimated accuracy of phase can be enhanced by correcting the blur amount, which is caused by a focal size of a radiation source, in X-ray intensity to be used in a solving method such as the finite-element method.

### BRIEF DESCRIPTION OF THE DRAWINGS

FIG. 1 is a view showing a construction of a phase information restoring apparatus according to one embodiment of the present invention;

FIG. 2 is a schematic view showing a construction of an imaging unit as shown in FIG. 1;

FIG. 3 is a view showing a construction of an X-ray tube for generating an X-ray;

FIG. 4 is a flow chart showing a phase information restoring method according to one embodiment of the present invention;

FIG. 5 is a view showing each of blur functions as a function of spatial frequencies;

FIG. 6 is a view showing a function to be used in a filter processing as a function of spatial frequencies;

FIG. 7 is a view showing a modified example of a construction of a phase information restoring apparatus according to one embodiment of the present invention;

FIG. 8 is a schematic view showing a construction of a reading unit as shown in FIG. 7; and

FIG. 9 is a view for explanation of the principle of the phase restoration.

### DESCRIPTION OF THE PREFERRED EMBODIMENTS

An embodiment of the present invention will be described below by referring to the drawings. The same constituent elements will be given with the same reference numerals and the descriptions thereof will be omitted.

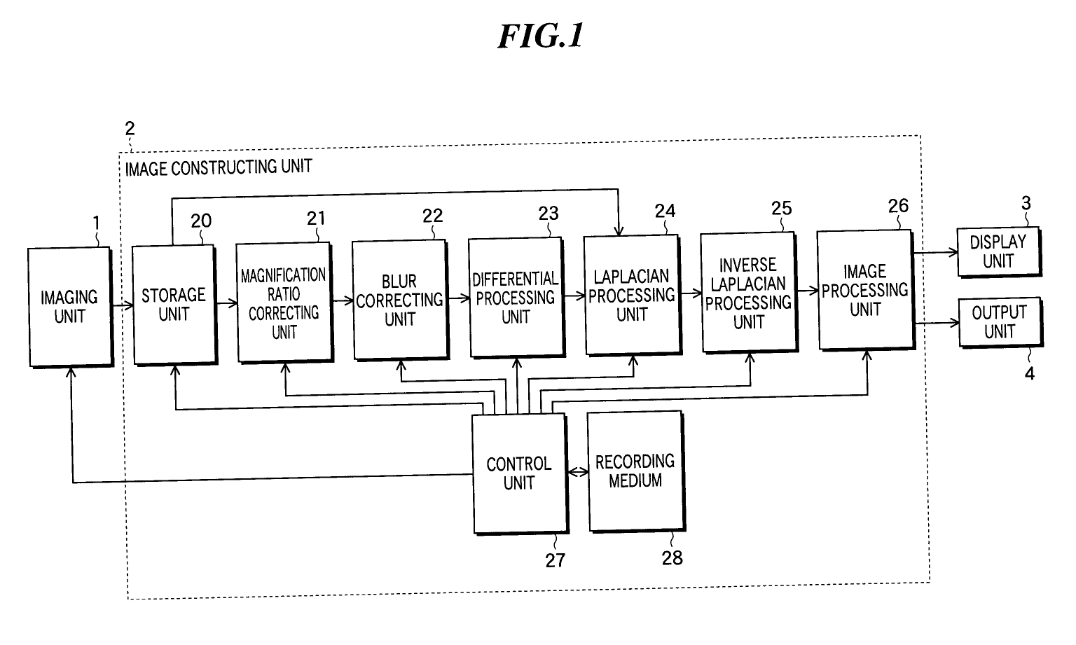

FIG. 1 shows a construction of a phase information restoring apparatus according to one embodiment of the present invention. As shown in FIG. 1, the phase information restoring apparatus has an imaging unit 1 for irradiating an object to be inspected with X-rays so as to output detection data representing radiation image information about the object, an image constructing unit 2 for restoring phase information on the basis of the detection data so as to generate image data, a display unit 3 for displaying a visible image on the basis of the image data, and an output unit 4 for printing out the visible image on a film or the like.

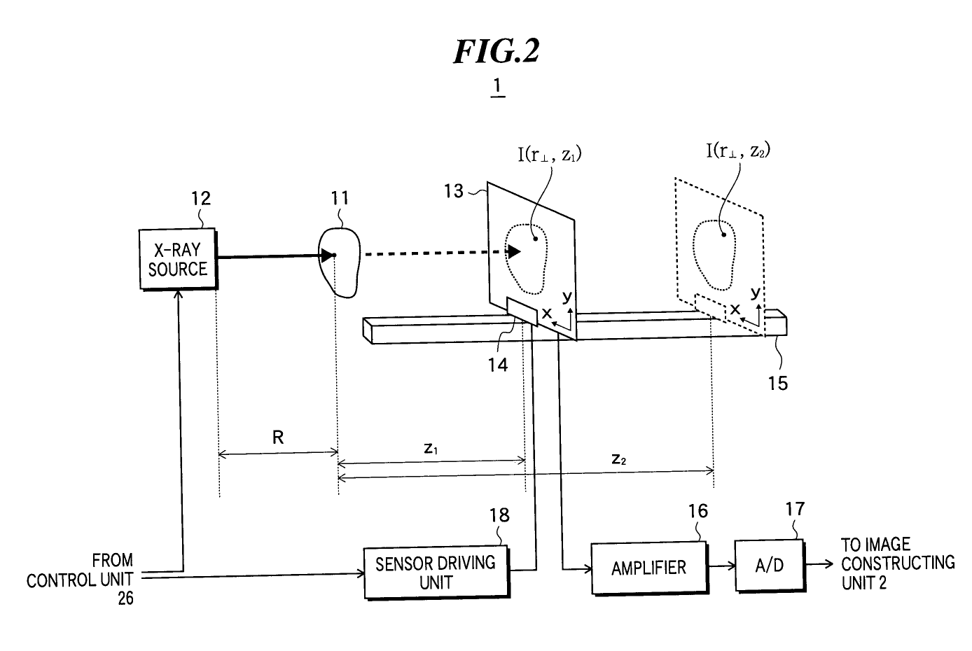

FIG. 2 is a schematic view showing a construction of the imaging unit 1. As for an X-ray source 12, an X-ray source capable of generating a beam having high coherency and high monochromaticity is preferably used. Here, the beam having high monochromaticity means a beam mainly having a single wavelength, however, is not necessarily a beam having a single wavelength in a strict sense. The X-rays generated from the X-ray source 12 transmit through an object 11 and enter a sensor 13 to produce diffraction fringes.

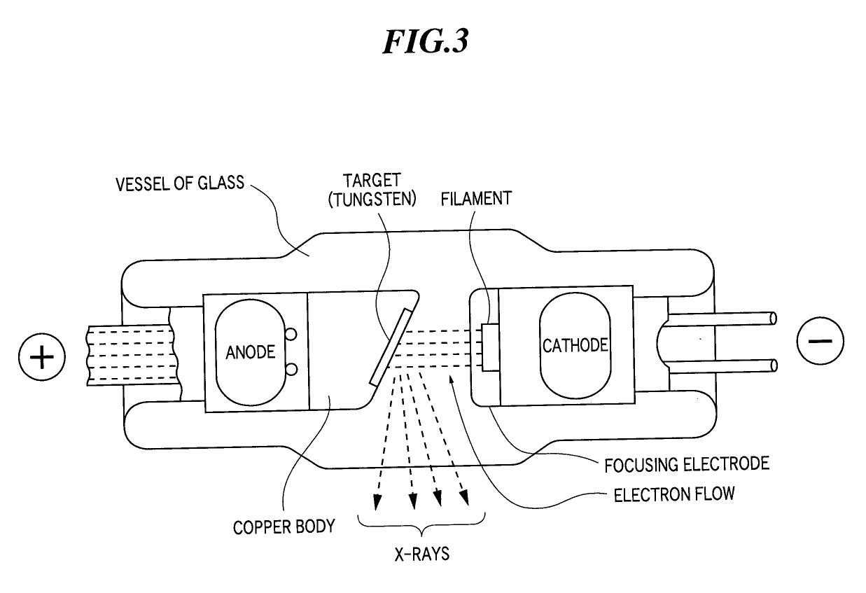

In this embodiment, an X-ray tube is used as the X-ray source 12. FIG. 3 shows construction of the X-ray tube for generating X-rays. As shown in FIG. 3, when a predetermined potential difference is given between an anode and a cathode, which have been enclosed in a vessel of glass, an electron flow is generated from a filament. The electron flow generated from the filament is focused by a focusing electrode so as to collide with a target (tungsten) set on a copper body in accordance with electric fields caused by the potential difference between the anode and the cathode. By this, X-rays are generated from the target. Therefore, the X-ray source is not a point radiation source, but the X-rays have a certain spread. The spread is referred to as a focal size of the X-ray source and is represented by using the standard deviation in the case of expressing the intensity distribution of the X-ray source in accordance with Gaussian distribution. Hereinafter, the standard deviations (focal size) of intensity distributions in the x and y directions are represented by σₓ and σ_{y}, respectively. Also, in the case of using a radiation source other than the X-ray tube, the focal size can be similarly considered.

Referring to FIG. 2, the sensor 13 is used as a screen for allowing X-rays to enter to produce diffraction fringes, and outputs detection signals representing intensity of diffraction X-ray which entered at each position of the sensor 13. As for the sensor 13, a two-dimensional sensor having a plurality of detecting elements, which convert intensity of the incident X-rays into an electric signal to output the electric signal as a detection signal, such as a CCD (charge coupled device) for example, is used.

The imaging unit 1 has an amplifier 16 and an A/D converter 17. The amplifier 16 amplifies the detection signal output from the sensor 13. The A/D converter 17 converts the detection signal amplified by the amplifier 16 into a digital signal (referred to as “image signal” or “detection data”) and outputs the detection data into the image constructing unit 2.

Further, the imaging unit 1 has a holding portion 14 for holding the sensor 13, a rail 15 for supporting the holding portion 14 in a movable state, and a sensor driving unit 18 for driving the holding portion 14. The sensor driving unit 18 changes distance between the object 11 and the sensor 13 by driving the holding portion 14 under the control of the control unit 27 of the image constructing unit 2, which will be described later. Hereinafter, the distance between the object 11 and the sensor 13 is referred to as an “imaging distance”.

Referring again to FIG. 1, the image constructing unit 2 has a storage unit 20 for temporarily storing the detection data output from the imaging unit 1, a magnification ratio correcting unit 21 for uniforming magnification ratios of the detection data having different imaging distances, a blur correcting unit 22 for uniforming the blur amount of the detection data having different imaging distances, a differential processing unit 23 for obtaining a differential coefficient between the detection data having different imaging distances, a Laplacian processing unit 24 for calculating values equivalent to Laplacian of phase, an inverse Laplacian processing unit 25 for performing an inverse Laplacian operation to restore the phase information, an image processing unit 26 for generating image data on the basis of the restored phase information, and the control unit 27 for controlling the respective units 20-26 and the imaging distance in the imaging unit 1. The image constructing unit 2 may be constituted of a digital circuit, or of software and a CPU. In the latter case, the control unit 27 including the CPU processes the detection data on the basis of the phase information restoring program recorded in the recording medium 28. As the recording medium 28, a flexible disk, hard disk, MO, MT, RAM, CD-ROM, DVD-ROM and so on are applicable.

The display unit 3 is, for example, a display device such as a CRT and displays a visible image on the basis of the image data representing the phase information restored by the image constructing unit 2. The output unit 4 is, for example, a laser printer and prints out a visible image on a film or the like on the basis of the image data.

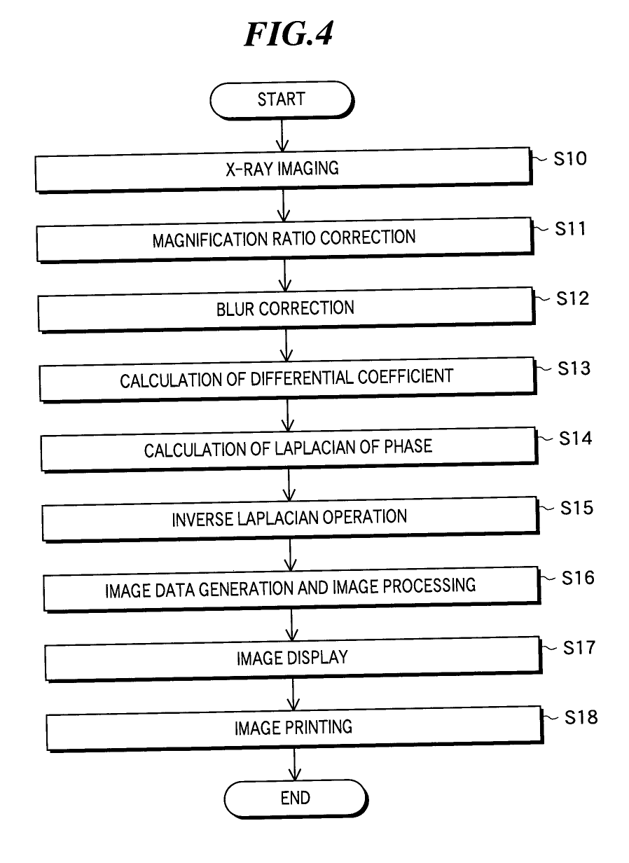

Next, referring to FIGS. 1, 2 and 4, a phase information restoring method according to one embodiment of the present invention will be described. FIG. 4 is a flow chart showing the phase information restoring method according to one embodiment of the present invention. In this embodiment, as shown in FIG. 2, a visible image is constructed by using the detection data representing two sheets of diffraction fringe images which are imaged by altering the imaging distance.

First, at step S10, the X-ray imaging is performed. More specifically, as shown in FIG. 2, the object is disposed at a distance of R from the X-ray source 12, and the sensor 13 is disposed at an imaging distance of z₁ by the sensor driving unit 18 which is controlled by the control unit 27. In this state, X rays are irradiated on the object 11, thereby performing the X-ray imaging. Next, the sensor 13 is disposed at an imaging distance of z₂ and the X-ray imaging is performed in the same manner.

Through the X-ray imaging at step S10, detection data I(x, y, z₁) and I(x, y, z₂) representing intensity of diffracted X-ray which entered respective pixels (x, y) on the planes at imaging distances of z₁ and z₂ are sequentially input into the image constructing unit 2 and stored in the storage unit 20. The two sets of detection data represent diffraction fringe image information at respective imaging distance planes.

Next, at steps S11-S16, the image constructing unit 2 restores phase φ(x, y) at a sensor position on the basis of the detection data I(x, y,z₁) and I(x, y, z₂) stored in the storage unit 20.

First, at step S11, the magnification ratio correcting unit 21 uniforms the magnification ratios of the detection data I(x, y, z₁) and I(x, y, z₂). For example, when the detection data I(x, y, z₁) represents an image of M times the object 11 and the detection data I(x, y, z₂) represents an image of N times the object 11, an interpolation enlargement image processing is performed to enlarge the detection data I(x, y, z₁) to N/M times, or an interpolation enlargement image processing may be performed to enlarge the detection data I(x, y, z₂) to M/N times.

Next, at step S12, the blur correcting unit 22 uniforms the blur amounts of the detection data I(x, y, z₁) and I(x, y, z₂). Here, referring to FIG. 5, a detection signal obtained by detecting, using the sensor 13, X-rays generated from an X-ray source having a finite focal size will be described. On an image obtained by X-rays generated from the X-ray source 12 having a finite focal size, blur is produced. A blur function f(u, v) representing the blur of the image shows a normal distribution represented by the following expression (5). Here, a distance between the object 11 and the X-ray source 12 is R, an imaging distance between the object 11 and the sensor 13 is z, and focal sizes in the X-axis direction and Y-axis direction of the X-ray source are σₓ and σ_{y}, respectively.

$$f ( u , v ) = exp [ - \frac{1}{2} {a}_{X}^{2} {z}^{2} {u}^{2} - \frac{1}{2} {a}_{Y}^{2} {z}^{2} {v}^{2} ] \qquad ( 5 )$$

In the expression (5), u and v represent spatial frequency components in the x-axis direction and y-axis direction in the sensor 13, respectively. Further, aₓ=2nσₓ z/R, a_{y}=2nσ_{y} z/R.

FIG. 5 shows the blur functions as the functions of spatial frequencies. In FIG. 5, f₁(u, v) and f₂(u, v) represent the blur functions at different distances of z₁ and z₂, respectively, as represented by the expression (6) and the expression (7).

$$\begin{matrix}{f}_{1} ( u , v ) = exp [ - \frac{1}{2} {a}_{X}^{2} {z}_{1}^{2} {u}^{2} - \frac{1}{2} {a}_{Y}^{2} {z}_{1}^{2} {v}^{2} ] & ( 6 ) \\ {f}_{2} ( u , v ) = exp [ - \frac{1}{2} {a}_{X}^{2} {z}_{2}^{2} {u}^{2} - \frac{1}{2} {a}_{Y}^{2} {z}_{2}^{2} {v}^{2} ] & ( 7 )\end{matrix}$$

As shown in FIG. 5, the blur functions at different distances are different from each other, and therefore, even if phase information is obtained by using plural sets of detection data having non-uniform blur amounts as in a conventional method, an error is produced depending on the difference between the blur amounts of detection data. Consequently, in the present invention, a process of uniforming the blur amounts of the detection data I(x, y, z₁) and I(x, y, z₂) is performed.

In the case of correcting the blur amount of the detection data I(x, y, z₂) so as to uniform it to the blur amount of the detection data I(x, y, z₁), the detection data I(x, y, z₂) is subjected to a filter processing on the basis of the following expression (8).

$$\frac{{f}_{1} ( u , v )}{{f}_{2} ( u , v )} = exp [ - \frac{1}{2} ( {a}_{X}^{2} {u}^{2} + {a}_{Y}^{2} {v}^{2} ) ( {z}_{1}^{2} - {z}_{2}^{2} ) ] \qquad ( 8 )$$

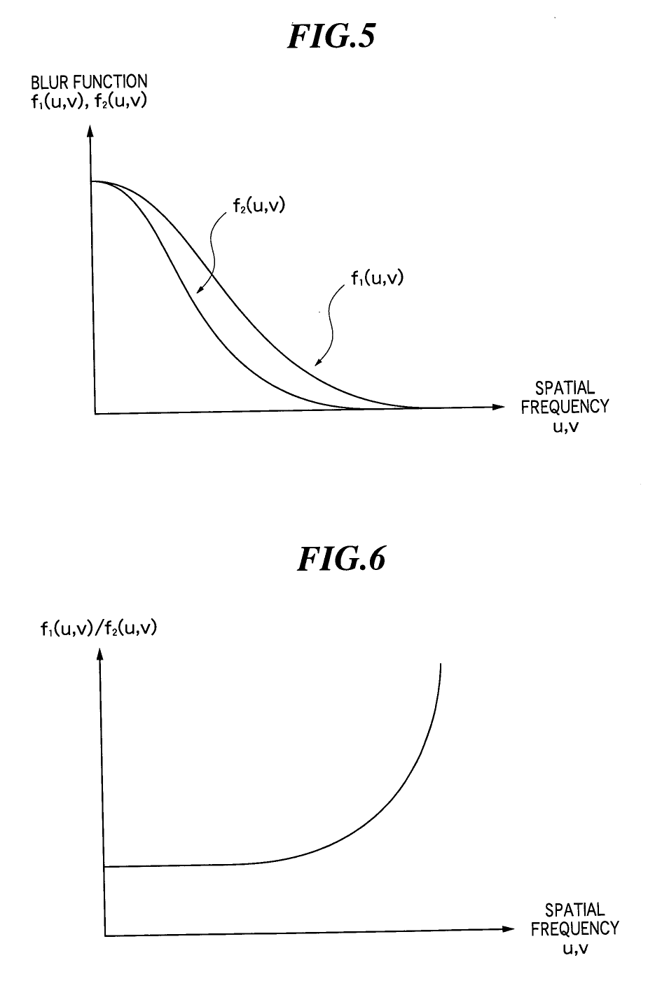

FIG. 6 shows a function of the expression (8) to be used for the filter processing as a function of spatial frequencies.

Accordingly, the detection data I′(x, y, z₂) where the blur amount has been corrected are represented as the following expression (9).

$$\begin{matrix}{I}^{′} ( x , y , {z}_{2} ) = {F}^{- 1} [ {I}_{2}^{′} ( u , v ) ] \\ = {F}^{- 1} [ {I}_{2} ( u , v ) ] \times \frac{{f}_{1} ( u , v )}{{f}_{2} ( u , v )} ] \\ = {F}^{- 1} [ F [ I ( x , y , {z}_{2} ) ] \times \frac{{f}_{1} ( u , v )}{{f}_{2} ( u , v )} ]\end{matrix} \qquad ( 9 )$$

Where, I₂(u, v) represents a spatial frequency component of I(x, y, z₂), and I′₂(u, v) represents a spatial frequency component of I(x, y, z₂) in which the blur amount has been corrected. Further, F[ ] represents Fourier transform, and F⁻¹[ ] represents inverse Fourier transform.

In this embodiment, the blur amount of the detection data I(x, y, z₂) is corrected so as to uniform it to the blur amount of the detection data I(x, y, z₁). However, the blur amount of the detection data I(x, y, z₁) may be corrected so as to uniform it to the blur amount of the detection data I(x, y, z₂). Alternatively, the respective blur amounts of the detection data I(x, y, z₁) and I(x, y, z₂) may be corrected so as to uniform them to a third blur amount which is different from the blur amounts of the detection data I(x, y, z₁) and I(x, y, z₂).

Next, at step S13, the differential processing unit 23 obtains a difference between the detection data I(x, y, z₁) and I′(x, y, z₂) by using the following expression (10).

$$\frac{\partial I ( x , y , z )}{\partial z} = \frac{{I}^{′} ( x , y , {z}_{2} ) - I ( x , y , {z}_{1} )}{{z}_{2} - {z}_{1}} \qquad ( 10 )$$

Next, at step S14, the Laplacian processing unit 24 obtains Laplacian f(x, y, z)=∇²φ(x, y, z) of phase by using the following expression (11) on the basis of the differential coefficient obtained at step S13 and the detection data stored in the storage unit 20.

$$f ( x , y , z ) = - \frac{κ}{I ( x , y , {z}_{1} )} \frac{\partial I ( x , y , z )}{\partial z} \qquad ( 11 )$$

Here, in the expression (11), the differential coefficient is divided by the detection data I(x, y, z₁) where the blur amount is not corrected. However, the differential coefficient may be divided by the detection data I(x, y, z₂) where the blur amount is not corrected, or the differential coefficient may be divided by the detection data I′(x, y, z₂) where the blur amount has been corrected.

Further, at step S15, the inverse Laplacian processing unit 25 performs an inverse Laplacian computation on the Laplacian f(x, y, z)=∇²φ(x, y, z) of phase, which has been obtained at step S14, to obtain the phase φ(x, y, z).

Here, the inverse Laplacian operation will be described in detail. The Fourier transform of f(x, y, z) is represented as the following expression (12).

F[f(x,y,z)]=F[∇²φ(x,y,z)]=−4π²(u²+v²)F[φ(x,y,z)] (12)

Accordingly, the phase φ(x, y, z) is represented as the following expression (13).

$$φ ( x , y , z ) = {F}^{- 1} [ - \frac{1}{4 {π}^{2} ( {u}^{2} + {v}^{2} )} F [ f ( x , y , z ) ] ] \qquad ( 13 )$$

By utilizing the expression (13), an inverse Laplacian operation can be performed. Specifically, f(x, y, z) is Fourier transformed, then the result obtained is multiplied by {−4π²(u²+v²))⁻¹ and the product is further inverse Fourier transformed to obtain the restored phase φ(x, y, z).

Here, a value of {−4π²(u²+v²)}⁻¹ may be previously calculated within a range where each of |u| and |v| is a predetermined value or less to be utilized in performing the operation represented by the expression (13). In other words, a predetermined value “const” is set and in the case where |u|, |v|=<const, a value of the following expression is used in the expression (13).

{−4π²(u²+v²)}⁻¹=(the previously calculated value)

On the other hand, in the case where |u|, |v|>const, a value of the following expression is used in the expression (13).

{−4π²(u²+v²))⁻¹=0

By virtue of this, an inverse Laplacian operation can be performed at a high speed.

Next, at step S16, the image processing unit 26 generates image data on the basis of the restored phase φ(x, y, z). Specifically, the image processing unit 26 converts the phases φ(x, y, z) in the respective pixels into the data showing brightness, and then, performs a necessary image processing such as a gradation processing or an interpolation processing to the image data.

Thereafter, as the need arises, the display unit 3 displays a visible image on the basis of the image data on a display at step S17, or the output unit 4 prints it out on a film or the like at step S18.

Although the X-ray tube is used as a radiation source generating X-rays in this embodiment, radiation sources other than the X-ray tube may be used. For example, a synchrotron radiation source, which utilizes radiation (electromagnetic wave) generated by accelerating an electron or bending a traveling direction of the electron, may be used. In the synchrotron radiation source, the wavelength of generated X-rays can be altered by altering the acceleration of an electron. As for further radiation source for generating X-rays, for example, an electron storage type high brightness hard X ray generating apparatus developed by Ritsumeikan University may be used. The apparatus can generate X-rays having high luminance and directivity just like the synchrotron radiation, though it is a desktop apparatus. X-rays generated by the apparatus have coherency and also can be rendered monochromatic by combination with a monochromatizing crystal though they have not a single wavelength. Alternatively, a radiation source developed by the Femtosecond Technology Research Association (FESTA) generates ultra-short pulse high-brightness X-ray on the basis of the principle of inverse Compton scattering. The X-ray source is compact and portable, and can generate the X-rays having not only coherency but also high directivity and monochromaticity.

Although X-rays are used for imaging an object in this embodiment, not only X-rays but also any other beams may be used as long as the beam transmits through the object to form a diffraction figure. As for such a beam, for example, a corpuscular beam including an electron beam can be mentioned.

Further, in this embodiment, the phase is restored using two sets of detection data having different imaging distances. Alternatively, the phase may also be restored using three or more sets of detection data having different imaging distances.

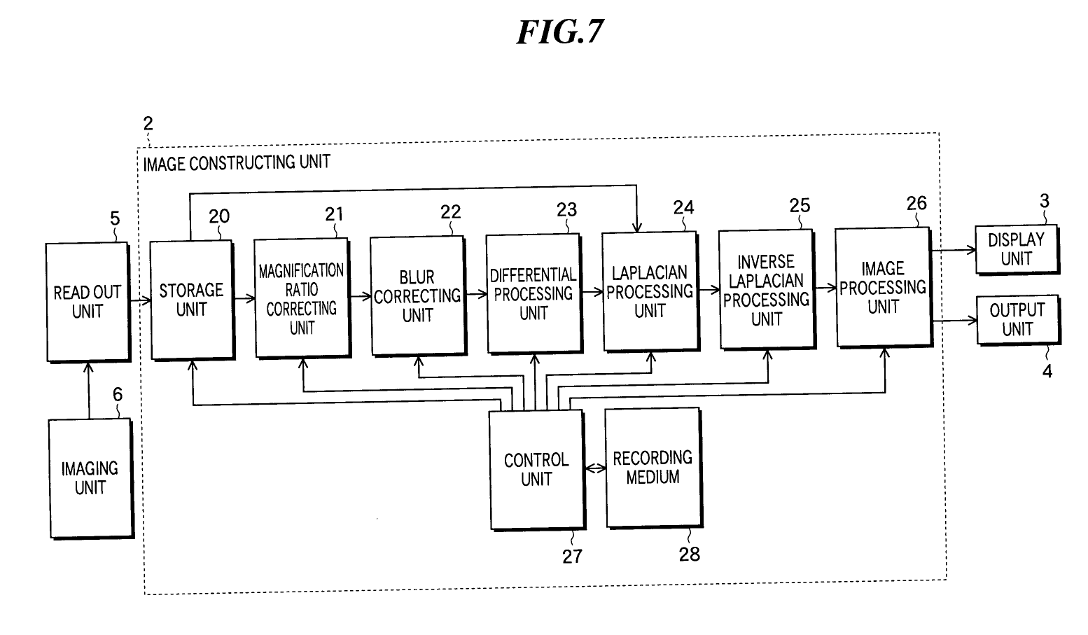

Next, referring to FIG. 7, a modified example of a phase information restoring apparatus according to one embodiment of the present invention will be explained. The phase information restoring apparatus as shown in FIG. 7 has an imaging unit 6 and a read unit 5. Other constructions are similar to those of the phase information restoring apparatus as shown in FIG. 1.

In the imaging unit 6, as for a screen to be used for recording the image information, a photostimulable phosphor sheet (record sheet) is used in place of the sensor 13 as shown in FIG. 2.

The photostimulable phosphor (storage phosphor) is a substance that, when irradiated by radiation or the like, stores a part of the radiation energy and that, when an excitation light such as visible light is then irradiated, emits stimulated fluorescence corresponding to the stored energy. On performing radiation imaging, a radiation image of an object such as a human body is imaged and recorded on a sheet coated with the photostimulable phosphor, and when the photostimulable phosphor sheet is scanned by the excitation light such as laser light, stimulated fluorescence is generated. By photoelectrically reading out the stimulated fluorescent light, the detection data can be obtained. The detection data is appropriately processed and output to a display such as a CRT or output to a laser printer for printing an image on a film, so that the radiation image can be displayed as a visible image.

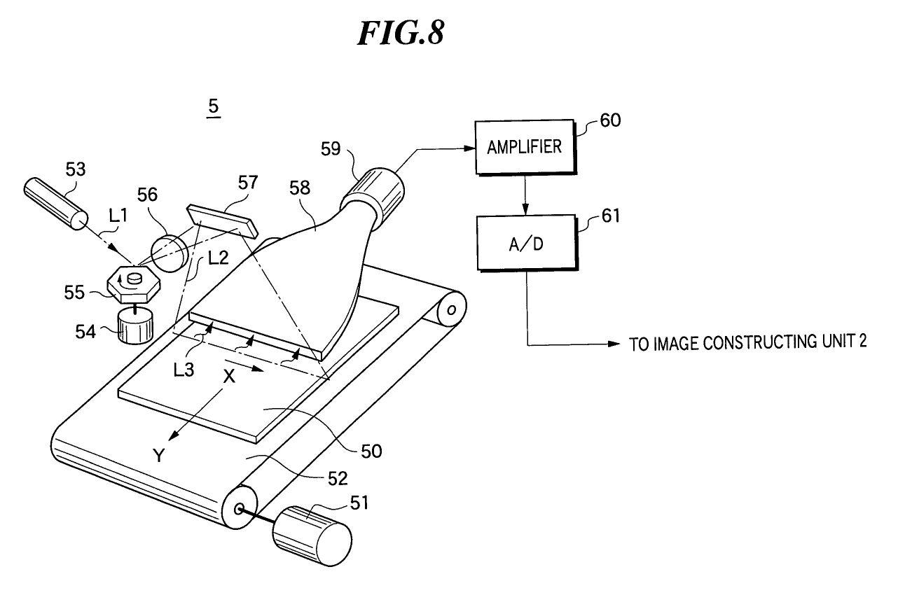

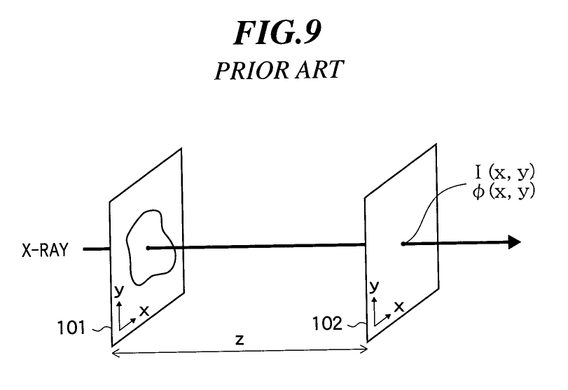

The read unit 5 as shown in FIG. 7 is used for reading out the radiation image recorded in the record sheet. Referring to FIG. 8, construction and operation of the read unit 5 will be explained. The record sheet 50, on which the image information has been recorded, is set in a predetermined position of the read unit 5. The record sheet 50 is carried in the Y-axis direction with a sheet carrier unit 52 driven by a motor 51. On the other hand, a beam L1 oscillated from a laser light source 53 is reflected and deflected by a rotational polygon mirror 55 which is driven by a motor 54 to rotate at a high speed in the direction indicated by an arrow and passes through a convergent lens 56. Then, the beam L1 is forced to change a light path by a mirror 57 and scans the record sheet 50 in the X-axis direction. By the scanning, excitation light L2 is irradiated on the record sheet 50 and from an irradiated part, stimulated fluorescent light L3 having quantity corresponding to the radiation image information stored and recorded is emitted. The stimulated fluorescent light L3 is guided by a light guide 58 and photoelectrically detected by a photomultiplier 59. An analogue signal output from the photomultiplier 59 is amplified by an amplifier 60 and digitized by an A/D converter 61. Detection data output from the A/D converter 61 are input into the image constructing unit 2.

In the modified example, the imaging unit 6 performs each radiation imaging at the different imaging distances by using a plurality of record sheets, and the read unit 5 reads out the image information from the respective record sheets. As a result, detection data representing a plurality of diffraction fringe images obtained at different imaging distances can be obtained. The image constructing unit 2 performs the phase restoration on the basis of these detection data to generate the image data. The processing in the image constructing unit 2 is similar to that described by referring to FIG. 4.

According to the present invention, the estimated accuracy of phase can be enhanced by uniforming the amounts of blue, which is caused by a focal size of a radiation source, in X-ray intensity for use in a solving method such as the finite-element method.

1. A method of restoring phase information on radiation transmitted through an object on the basis of detection data obtained by detecting intensity of the radiation transmitted through the object, said method comprising the steps of:
(a) correcting blur amount for at least one of plural sets of detection data obtained by detecting intensity of radiation on plural detection planes at different distances from the object, said plural sets of detection data representing radiation image information on the plural detection planes, respectively;
(b) obtaining differential data representing difference between first detection data and second detection data of said plural sets of detection data where the blur amount has been corrected for at least one thereof;
(c) obtaining Laplacian of phase on the basis of said differential data and any one of said plural sets of detection data and the detection data in which the blur amount has been corrected; and
(d) obtaining phase data of the radiation by performing inverse Laplacian computation on the Laplacian of phase.

2. A method according to claim 1, wherein step (a) includes uniforming blue amounts caused by a focal size of a radiation source in said plural sets of detection data on the basis of respective blur functions of said plural sets of detection data.

3. An apparatus for restoring phase information on radiation transmitted through an object on the basis of detection data obtained by detecting intensity of the radiation transmitted through the object, said apparatus comprising:
blur correcting means for correcting blur amount for at least one of plural sets of detection data obtained by detecting intensity of radiation on plural detection planes at different distances from the object, said plural sets of detection data representing radiation image information on the plural detection planes, respectively;
difference processing means for obtaining differential data representing difference between first detection data and second detection data of said plural sets of detection data where the blur amount has been corrected for at least one thereof;
Laplacian processing means for obtaining Laplacian of phase on the basis of said differential data and any one of said plural sets of detection data and the detection data in which the blur amount has been corrected; and
inverse Laplacian processing means for obtaining phase data of the radiation by performing inverse Laplacian computation on the Laplacian of phase.

4. An apparatus according to claim 3, wherein said blur correcting means uniforms blue amounts caused by a focal size of a radiation source in said plural sets of detection data on the basis of respective blur functions of said plural sets of detection data.

5. A program for restoring phase information on radiation transmitted through an object on the basis of detection data obtained by detecting intensity of the radiation transmitted through the object, said program actuating a CPU to execute the procedure of:
(a) correcting blur amount for at least one of plural sets of detection data obtained by detecting intensity of radiation on plural detection planes at different distances from the object, said plural sets of detection data representing radiation image information on the plural detection planes, respectively;
(b) obtaining differential data representing difference between first detection data and second detection data of said plural sets of detection data where the blur amount has been corrected for at least one thereof;
(c) obtaining Laplacian of phase on the basis of said differential data and any one of said plural sets of detection data and the detection data in which the blur amount has been corrected; and
(d) obtaining phase data of the radiation by performing inverse Laplacian computation on the Laplacian of phase.

6. A program according to claim 5, wherein procedure (a) includes uniforming blue amounts caused by a focal size of a radiation source in said plural sets of detection data on the basis of respective blur functions of said plural sets of detection data.
